(19) United States
(12) Patent Application Publication
(10) Pub. No.: US 2012/0327968 A1
(43) Pub. Date: Dec. 27, 2012

(54) ELECTRODE ARM OF A METALLURGICAL MELTING FURNACE

(75) Inventors: Gereon Fehlemann, Dusseldorf (DE); Dirk Lieftucht, Legden (DE)

(73) Assignee: SMS SIEMAG AKTIENGESELLSCHAFT, DUSSELDORF (DE)

(21) Appl. No.: 13/580,126

(22) PCT Filed: Feb. 8, 2011
(86) PCT No.: PCT/EP11/51773

§ 371 Date: Sep. 12, 2012

(30) Foreign Application Priority Data
Feb. 18, 2010 (DE) 10 2010 008 503.0
Jun. 26, 2010 (DE) 10 2010 025 236.0

(51) Int. Cl. H05B 7/06

(52) U.S. Cl. 373/88

(57) ABSTRACT

The invention relates to an electrode arm (1) of a metallurgical melting furnace, especially an arc furnace, the electrode arm (1) having at least one measuring element (2) for measuring a physical variable. To allow improved and more precise measurement of the physical variable required for operation of the furnace, the measuring element (2) is designed to measure the temperature and/or the mechanical elongation of the electrode arm (1), the measuring element (2) comprising at least one optical waveguide (3) which extends along the longitudinal extension (L) of the electrode arm (1) in at least some sections.

The invention concerns an electrode jib arm of a smelting reduction furnace, especially an electric arc furnace, wherein the electrode jib arm is equipped with at least one measuring element for measuring a physical quantity.

DE 27 50 271 A1 discloses an electrode system with an electrode jib arm of a generic type. In smelting reduction furnaces, especially electric arc furnaces, mounting devices for the required electrodes are used. These devices generally consist of a support mast that supports an electrode jib arm. An electrode is mounted on the far end of the electrode jib arm away from the support mast in such a way that it extends vertically downward, i.e., it is suspended at the end of the electrode jib arm. Power is usually supplied from a power source to the electrode through copper-clad steel plates, of which the jib arm is constructed. In this regard, the steel plate basically performs the mechanical support function, while the copper cladding conducts the current.

The cited document also already explains that the electrode jib arm can be equipped with sensor elements in the form of load cells and strain gages. These sensors are used to detect the deformation of the jib arm. The data thus determined with sensors can then be compared with set values by means of a measured data evaluation unit,

DE 27 50 186 A1, DE 36 08 338 A1, EP 1 537 372 B1, and EP 0 094 378 B1 describe similar electrode systems.

A disadvantage of these previously known systems—to the extent that they even deal with the question of data acquisition in the electrode jib arm—is that due to the high current intensity through the electrode jib arm, high electric interference fields are present, which sensitively disturb both thermocouples and strain gages. Therefore, it is difficult to make exact determinations of thermal data (i.e., temperatures) and mechanical data (i.e., stresses and strains), which, of course, is necessary for optimum electrode operation.

The objective of the present invention is to further develop an electrode jib arm of the aforementioned type in such a way that it is possible to determine thermal and/or mechanical loads of the electrode jib arm as exactly as possible and thus to improve control of the operation of the electrode system. The goal is thus to achieve efficient monitoring of the electrode jib arm. In this regard, it should become possible to realize continuous and precise monitoring of the temperatures and the mechanical stresses of the electrode jib arm in a way that is cost-effective.

The solution to this problem by the invention is characterized in that the measuring element in the electrode jib arm is designed to measure the temperature and/or the mechanical strain of the electrode jib arm, where said measuring element comprises at least one optical waveguide that extends in the longitudinal direction of at least some sections of the electrode jib arm.

It is possible for the optical waveguide to be arranged in a tube that encloses it.

The optical waveguide and the tube that possibly encloses it can be arranged in a bore in the electrode jib arm.

Alternatively, it is possible for the optical waveguide and the tube possibly enclosing it to be arranged in a groove in the electrode jib arm. The groove can be sealed by a sealing element, which holds the optical waveguide and the tube possibly enclosing it in the bottom of the groove, where the sealing element is especially a metal part inserted in the groove or cast in the groove. The sealing element is preferably joined with the groove by friction stir welding. Friction stir welding has the advantage that the welding temperature can be controlled very well, which makes it possible to prevent the optical waveguide within the groove from becoming too hot.

Another alternative provides that the optical waveguide and/or the tube possibly enclosing it are arranged in a layer arranged in or on the electrode jib arm. The layer can consist of metal or of a heat-resistant nonmetallic material. The optical waveguide and the tube possibly enclosing it can be completely surrounded by the material of the layer. The layer can be applied in or on the electrode jib arm by electroplating. It can consist of copper, chromium, or nickel. The layer can be applied by thermal spray coating or chemical coating, as disclosed, for example, in DE 10 2009 04979.0.

The placement of optical waveguides in the walls and supporting elements of the electrode jib arm makes it possible to measure temperatures and/or stresses and strains in the structural members of the electrode jib arm as temperature or stress profiles over the surface of the electrode jib arm. Dynamic changes caused by flows in the molten metal in the vessel beneath the jib arm are also detected. This makes it possible to assess the state of wear and the existing stress situation of the jib arm due to the temperature and/or stress. The proposed concept makes it possible to describe the thermal and mechanical stress on the structural members over their surface in the given operating state.

To make it possible to carry out exact measurements with the optical waveguide, it is advantageous for the optical waveguide or the metal tube that encloses the optical waveguide to lie close against the part or medium and, in particular, if at all possible, without an (insulating) air gap, so that good heat transfer to the optical waveguide can occur. Of course, for temperature measurements, the optical waveguide must not be mounted tightly, because it must be able to expand or contract when a temperature change occurs.

On the other hand, for strain measurements with the optical waveguide, it is necessary for the optical waveguide to be firmly joined with the member whose strain or strain variation with respect to time is to be measured, so that the mechanical strain of the member is transferred to the optical waveguide.

To make it possible also to measure the strain (stress) of the wall of the electrode jib arm, it is advantageous if the optical waveguide or the tube enclosing it is firmly joined with the bore or the bottom of the groove.

If a groove is provided, in which the optical waveguide or the tube enclosing it is installed, it is preferably provided that a filler piece, which can be made of metal, is used for sealing the groove. It can be designed to conform precisely to the shape of the groove. In this regard, it can also be provided that the filler piece is produced by casting or injection of the material of the filler piece into the groove. Thus, in this case, the material of which the filler piece consists is made castable or injectable and then cast or injected into the groove in which the optical waveguide, which is possibly enclosed in a tube, was inserted.

The proposed design offers the possibility of detecting stress states in the measured plane and thus determining the mechanical load on the members.

The technology of the measurement of temperatures, strains or stresses and/or accelerations from the distribution of the measured strains with respect to time in itself is already well known (including under the term “optical strain gages”), so that in this respect the relevant prior art can be consulted.

The optical waveguide is preferably connected with an evaluation unit, in which the temperature distribution in the electrode jib arm can be determined. This evaluation unit can also be similarly used to determine the mechanical load on the wall of the electrode jib arm.

A specific embodiment of the invention is illustrated in the drawings.

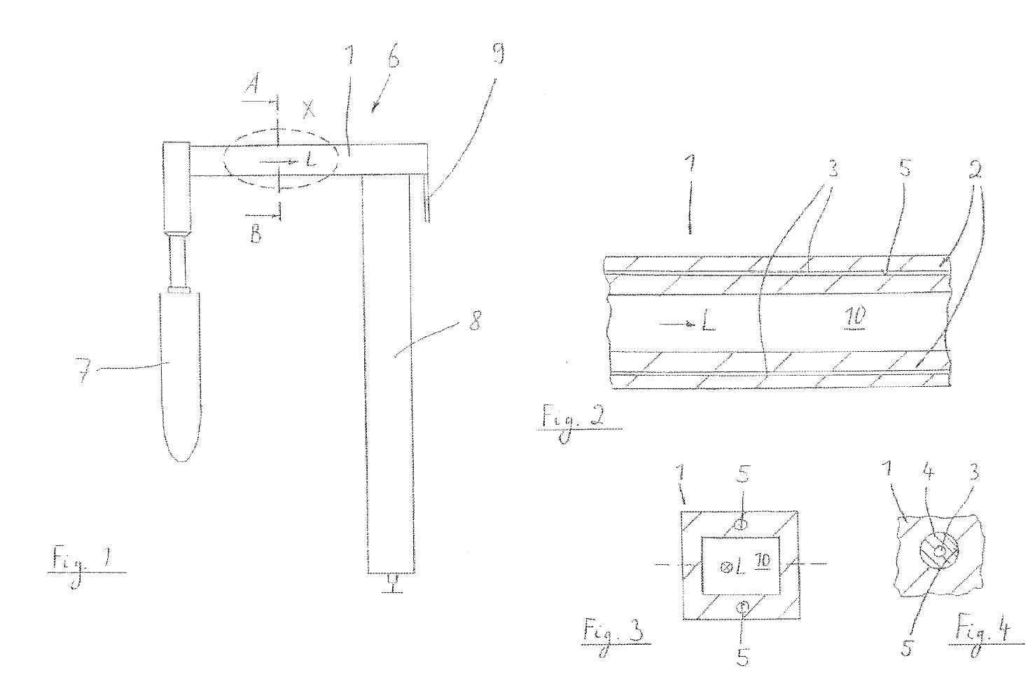

FIG. 1 is a schematic side view of an electrode system of an electric arc furnace with a horizontally extending electrode jib arm.

FIG. 2 is a cutaway view of detail “X” in FIG. 1.

FIG. 3 is a cross section along sectional line A-B in FIG. 1.

FIG. 4 is an enlarged view of the region of a bore in FIG. 3.

FIG. 1 shows an electrode system 6 used in an electric arc furnace. The electrode system 6 has a vertical support mast 8. A horizontal electrode jib arm 1 is mounted on the upper end of the support mast 8. An electrode 7, which generates the electric arc in the electric arc furnace, is suspended at the opposite end of the electrode lib arm 1 from the support mast 8. The longitudinal extent L of the electrode jib arm 1 corresponds to the horizontal direction in the present case. The electrode 7 is supplied with power through a power supply connection 9.

The electrode jib arm 1 consists of steel plate, which provides sufficient mechanical strength. It is plated with copper to ensure good electrical conduction of the current from the power supply connection 9 to the electrode 7.

As the cross-sectional views in FIG. 2 and FIG. 3 show, the electrode jib arm 1 is liquid-cooled. To this end, the electrode jib arm 1 has a cooling channel 10, through which a cooling medium flows. The medium supply lines needed for this are not shown in the drawings.

To allow exact determination of both the temperature and strains in the electrode jib arm 1, the upper and lower regions of the electrode jib arm 1 are each provided with a bore 5 (see FIGS. 2 and 3), which accommodates a measuring element 2 for measuring the temperature and stress. The measuring element consists of an optical waveguide 3 housed in a protective tube 4. The two bores 5 are shown still empty in FIG. 3. FIG. 4 shows the bores 5 after the tubes containing the optical waveguides 3 have been inserted in them.

The optical waveguide 3 typically has a diameter of, e.g., 0.12 mm; with the enclosing tube 4, the overall diameter is usually in the range of 0.8 mm to 2.0 mm.

The optical waveguide 3 consists of a primary fiber, which is placed in the bores 5 or in similar channels or grooves in the electrode jib arm 1. In this regard, the optical waveguide 3 can withstand continuously high temperatures up to 800° C. The tube 4 is provided only as an option and not as a requirement. The optical waveguide 3 without a tube 4 can detect strains especially well by virtue of its joining with the base material of the electrode jib arm 1. On the other hand, temperatures can be determined especially well by the optical waveguide 3 when it is installed in an enclosing tube 4.

FIG. 3 shows that a bore 5 for accommodating an optical waveguide 3 is provided in both the upper region and the lower region of the electrode jib arm 1. As is also apparent from FIG. 3, it would be possible to provide bores 5 for the placement of optical waveguides 3 in all four lateral regions of the profile.

In order to increase the robustness of the signal transmission in the optical waveguide 3 and to evaluation units (not shown), the light waves are guided by fiber optic lens connectors from the electrode jib arm in the given rest position to the evaluation unit.

In addition to the described possibility of installing the optical waveguide 3 in bores 5, there is also the preferred possibility of incorporating a groove in the electrode jib arm 1 and laying the optical waveguide 3 (possibly together with a tube 4) in the bottom of the groove. The groove can then be sealed again, and the measures mentioned above can be used for this purpose.

Another possibility is to place the optical waveguide 3—possibly together with the tube 4—in a layer that consists of a metallic material or a heat-resistant nonmetallic material, which is applied on the electrode jib arm 1.

Alternatively, the optical waveguides are optical waveguide sensors incorporated in modules, i.e., in prefabricated structural units. For a temperature measurement, the optical waveguides are installed loosely in the modules, so that a temperature-related change in length of the optical waveguide within the module is able to take place without stress. For a strain measurement, on the other hand, the optical waveguides are preferably firmly joined with the material of the module or with the housing of the module, so that a strain of the module or its housing is transferred to the optical waveguides. The modules with the optical waveguides are mounted on the electrode jib arm by adhesive bonding or welding and are thus operatively connected with it A strain or temperature change of the electrode jib arm is thus transferred to the optical waveguides via the module. The modules or the optical waveguides in the modules are suitable for measuring the mechanical stress or strain and/or—via the course of the strain with respect to time—the acceleration behavior of the member, here especially the electrode jib arm. For the acceleration measurement, a special measuring device may be required, which can be integrated in the module. Particularly the strain and acceleration measurement data can be used to damp, i.e., to correct, undesired oscillations of the member by automatic control engineering.

The layer described above can be applied (in the case of metal) by electroplating, with the optical waveguide 3 and the tube 4 being completely encased. The electroplated layer can consist, for example, of copper, chromium or nickel.

The optical waveguide 3 is connected with a temperature acquisition system and an acquisition system for mechanical stresses and strains (not shown). The acquisition system generates laser right, which is fed into the optical waveguide 3. The data collected by the optical waveguide 3 are converted by the acquisition system to temperatures or stresses and assigned to the various measurement locations.

The evaluation can be carried out, for example, by the Fiber Bragg Grating method (FBG method). In this method, suitable optical waveguides are used, which are given measuring points inscribed with a periodic variation of the refractive index or grating with such variations. Due to this periodic variation of the refractive index, the optical waveguide constitutes a dielectric mirror as a function of the periodicity for certain wavelengths at the measuring points. A temperature change at a point causes a change in the Bragg wavelength, with exactly this wavelength being reflected. Light that does not satisfy the Bragg condition is not significantly affected by the Bragg grating. The different signals of the various measuring points can then he distinguished from one another on the basis of differences in transit time. The detailed structure of such fiber Bragg gratings and the corresponding evaluation units are well known. The accuracy of the spatial resolution is determined by the number of inscribed measuring points. The size of a measuring point can be, for example, in the range of 1 mm to 5 mm.

Alternatively, temperature measurement can also be made by the Optical Frequency Domain Reflectometry method (OFDR method) or the Optical Time Domain Reflectometry method (OTDR method). These methods are based on the principle of fiber optic Raman backscattering, which exploits the fact that a temperature change at the point of an optical waveguide causes a change in the Raman backscattering of the optical waveguide material. The temperature values along a fiber can then be determined with spatial resolution by means of the evaluation unit (e.g., a Raman reflectometer), such that in this method an average is taken along a certain length of the waveguide. This length is about a few centimeters. The different measuring points are in turn separated from one another by transit time differences. The design of such systems for evaluation by the specified methods is already well known, as are the lasers needed to produce the laser light within the optical waveguide 3.

When the electrode jib arm 1 is equipped in the manner that has been explained, it becomes possible to monitor temperatures and/or strains, which can be utilized in the following way in the operation of the electrode system:

1. The conductivity of the current-carrying copper conductor of the electrode jib arm varies with temperature. With the exactly determined temperature values and knowledge of the corresponding conductivity of copper, a constant current flow can be adjusted or automatically controlled.

2. In addition, self-protection of the electrode jib arm is possible with knowledge of temperature and strain. These determined values can be compared with permissible values in an open-loop and closed-loop control system; the closed-loop control system can then predetermine corrections for the current flow and the position of the electrode jib arm, so that the permissible values can be maintained.

3. Another advantageous use is the avoidance of oscillations in the electrode system. Oscillations in the electrode jib arm, including limit cycles, can be recognized by the strain measurement. As a consequence, critical operating points can be avoided, and, in particular, the desired values for current and voltage can be adjusted in such a way, or the signal can be modulated in such a way, that the oscillation is counteracted and compensated.

The automatic control system of the actuating cylinder of the height control of the electrode jib arm usually serves as the greatest control mechanism for oscillation compensation (in this regard, see especially DE 36 08 338 A1, which was cited earlier). This automatic height control can be used for compensation of the oscillations and deformations identified by the strain measurement. For further information on this procedure, which in itself is already well known, see the paper by Prof. Dr.-Ing. Klaus Krüger, “Specifications for Modern Electrode Control Systems for Three-Phase Electric Arc Furnaces” in “elektrowärme international”, April 2007, Vulkan-Verlag GmbH, Essen, ISSN 0340-3521-K 5548 F.

### LIST OF REFERENCE NUMBERS

1 electrode jib arm
2 measuring element
3 optical waveguide
4 tube
5 bore
6 electrode system
7 electrode
8 support mast
9 power supply connection
10 cooling channel
L longitudinal extent

1. An electrode jib arm (1) of a smelting reduction furnace, especially an electric arc furnace, wherein the electrode jib arm (1) is equipped with at least one measuring element (2) for measuring a physical quantity, wherein the measuring element (2) is designed to measure the temperature and/or the mechanical strain of the electrode jib arm (1), said measuring element (2) comprising at least one optical waveguide (3) that extends in the longitudinal direction (L) of at least some sections of the electrode jib arm (1).

2. An electrode jib arm in accordance with claim 1, wherein the measuring element (2) in the form of the optical waveguide (3) is arranged, for the purpose of temperature measurement, loosely in or on the electrode jib arm in such a way that it is free of tension and can move freely, or, for the purpose of strain measurement, it is arranged—preferably over its entire length—in such a way that it is operatively connected with the material of the electrode jib arm to allow the strains it undergoes to be recorded.

3. An electrode jib arm in accordance with claim 1, comprising a measuring device for determining the variation of the strains of the electrode jib arm with respect to time and for determining the acceleration behavior of the electrode jib arm from the determined variation of the strains with respect to time.

4. An electrode jib arm in accordance with claim 1, wherein the optical waveguide (3) is arranged in a module, which is in firm operative connection with the electrode jib arm, such that the optical waveguide is arranged, for the purpose of temperature measurement, in such a way that it is free of tension and can move freely, or, for the purpose of strain measurement, in such a way that it is firmly embedded in the module.

5. An electrode jib arm in accordance with claim 3, wherein the measuring device for determining the acceleration behavior of the electrode jib arm is integrated in the module for strain measurement.

6. An electrode jib arm in accordance with claim 1, wherein the optical waveguide (3) and/or a tube (4) that possibly encloses it is arranged in a bore (5) in the electrode jib arm (1).

7. An electrode jib arm in accordance with claim 1, wherein the optical waveguide (3) and a tube (4) that possibly encloses it is arranged in a groove in the electrode jib arm (1).

8. An electrode jib arm in accordance with claim 7, wherein the groove is sealed by a sealing element, which holds the optical waveguide (3) and the tube (5) possibly enclosing it in the bottom of the groove, where the sealing element is especially a metal part inserted in the groove or cast in the groove and preferably joined with the groove by friction stir welding.

9. An electrode jib arm in accordance with claim 1, wherein the optical waveguide (3) and/or the tube (4) that possibly encloses it is arranged in a layer disposed in or on the electrode jib arm (1).

10. An electrode jib arm in accordance with claim 9, wherein the layer consists of metal, preferably copper, chromium or nickel, or of a heat-resistant nonmetallic material.

11. An electrode jib arm in accordance with claim 9, wherein the optical waveguide (3) and the tube (4) possibly enclosing it are completely surrounded by the material of the layer.

12. An electrode jib arm in accordance with claim 9, wherein the layer is applied in or on the electrode jib arm (1) by electroplating.

13. An electrode jib arm in accordance with claim 9, wherein the layer is applied in or on the electrode jib arm (1) by thermal spray coating or chemical coating.
